(19) United States
(12) Patent Application Publication
(10) Pub. No.: US 2026/0174057 A1
(43) Pub. Date: Jun. 25, 2026

(54) SYSTEM AND METHOD FOR CONTROLLING MOVEMENT OF LIVESTOCK ANIMALS

(71) Applicant: AGIS AUTOMATISERING B.V., Harmelen (NL)

(72) Inventors: Gerard Marie GRIFFIOEN, Harmelen (NL); Alan RIORDAN, Harmelen (NL); Gyman VAN DER TOL, Harmelen (NL); Joris VERGEER, Harmelen (NL); Marcel VAN AALST, Harmelen (NL); Paul RUMP, Harmelen (NL)

(73) Assignee: AGIS AUTOMATISERING B.V., Harmelen (NL)

(21) Appl. No.: 19/124,851

(22) PCT Filed: Oct. 25, 2023
(86) PCT No.: PCT/EP2023/079846

§ 371 Date: Apr. 25, 2025

(30) Foreign Application Priority Data
Oct. 26, 2022 (NL) 2033400

(51) Int. Cl. A01K 1/00; A01K 1/02

(52) U.S. Cl. CPC A01K 1/0029; A01K 1/0017; A01K 1/0023; A01K 1/0209

(57) ABSTRACT

A system (3) for controlling movement of livestock animals (C1, C2), such as cows, from a first area (A1) to selective ones of plural target areas (T1, T2, T3) is provided, comprising a sorting gate assembly (301L, 301R) for determining a path from the first area (A1) to a selective one of the target areas (T1, T2, T3) for a first livestock animal (C1), and a separation gate assembly (301L, 301R) for reversibly blocking the path for a consecutive livestock animal (C2). The sorting gate assembly (301L, 301R) is provided by first gate leaves (303L, 303R) of selectively lockable laterally opposite gates. The separation gate assembly (301L, 301R) is provided by second gate leaves (305L, 305R) of the gates moving together with the first gate leaf (303L, 303R) thereof and is configured to be operated by the first livestock animal (C1) for separating the first (C1) and the consecutive (C2) animals.

### TECHNICAL FIELD

The present disclosure relates to a system for controlling movement of livestock animals. In particular it relates to a system for controlling movement of livestock animals from a first area to selective ones of plural further areas.

### BACKGROUND

Livestock animal gates and sorting systems are known to isolate one or more specific animals from a herd of livestock animals, e.g. cows, to a holding area for further tasks, such as examination or treatment. Such isolation of one or more animals from a herd, referred to as sorting or drafting, is preferably done as the herd moves from one area to another area during its daily routine and as such should have minimal disruption to the herd's flow or stress levels.

Sorting systems are therefore generally known.

Typically, sorting of cows is done by having a switching gate system integrated into an alley along which the cows must pass in single file. The gate system will usually have three components; an RFID reader to identify cows and switch the gate direction, a cow separator to put spatial separation between consecutive cows, and a switching gate (or several gates) to change the path available to specific cows.

The RFID reader must be placed in such a manner that it reliably reads the identity of the cow that is to pass through the gate, and only that cow.

The purpose of the cow separator is to make sure that only the cow that has been read by the RFID reader is able to move in the desired direction. Cows can tend to move very close together and try to squeeze through the same openings and passageways, and a cow will usually try to follow the path of the cow directly in front of her. This can be a major issue for sorting accuracy, particularly if one cow is overlapping with the previous cow (or example the second's cow's head is besides, or above the hips of the cow in front). In this scenario the final gate that changes the path of cows that need to be sorted will not have space or time to change to force both cows move in different directions.

For the final component, there are several common ways to achieve the switch of paths for sorting cows. One is to simply have a several gates, say one gate going left of the cow's path, one on the right, and one allowing the cows to go straight on. Another configuration is to have a single switch gate that swings to the left and right, always leaving one side open and the other closed. These gates are usually moved with pneumatic pistons, and with speed and force such to be fast enough to quickly sort one cow before the next cow arrives.

This also applies to (sorting of) other livestock animals such as goats, llamas, etc.

WO 95/05735 discloses a device that has, in the entry zone (1), an entrance gate (2) and two animal-identification systems (3 and 4). Animal-identification system (4) keeps the entrance gate (2) open as long as animals with the same characteristics are identified. If an animal with different characteristics is detected, the entrance gate (2) is closed. The sorting switch (5) is switched by animal-identification system (3) into a position corresponding to the characteristics detected. The entrance gate (2) subsequently stays open until another change in characteristics is detected by animal-identification system (4). Thus, when groups of animals with the same identifying characteristics are passing through, the throughput is higher since the entrance gate (2) does not have to be closed after every animal.

WO 2009/128705 discloses an assembly consisting of a passageway, delimited by side delimitations, for livestock, such as cattle, from a first space to a second space, wherein a one-way gate system, which can allow merely passage to the second space, is mounted in the passageway, wherein the gate system has at least one self-closing gate leaf which is movable between a closed position and one or more open positions, including a pass position wherein for an animal from the livestock passage to the second space is possible, wherein the gate leaf is arranged for movement to an open position by the exertion of pressure by an animal from the livestock passing through the passageway to the second space, wherein the assembly is also provided with means for determining an ID of an animal from the livestock, with means for blocking the gate leaf from moving into a pass position, which detainment means can be activated to a blocking position in response to data from the ID determining means.

Further, WO 2013/095294 relates to a gate arrangement to a fenced area for at least one animal. The gate arrangement comprises a gate (2d2, 2d3) movably arranged between a closed position and open position in an opening to the fenced area (2), and a lock mechanism (8, 8a, 8b) capable of locking the gate (2d2, 2d3) when it is in the closed position. The lock mechanism (8, 8a, 8b) is configured to lock the gate (2d2, 2d3) in the closed position by a specific locking force such that it is possible to open the gate (2d2, 2d3) by applying a larger force than the specific force on the gate (2d2, 2d3), and the gate arrangement comprises force adjusting means (5) configured to set the lock mechanism (8, 8a, 8b) in an unlocked state and in at least two different locked states, in which the gate (2d2, 2d3) is locked by two different specific locking forces.

U.S. Pat. No. 5,979,365 discloses an animal sorting module including a general frame (1) assembly defining a passageway (2) through which an animal can travel, the frame having a single entry point opening (3) at or near a first end (4) and two exit point openings (6) at or near a second end (7) wherein the entry point and at least one of the exit points are defined by a pair of elongate substantially cylindrical rollers (8) which can be moved between a first position occluding the opening and a second position exposing the opening.

AU 2004 202081 discloses a stock drafting device. The document relates to a device for separating a herd of animals into two or more herds.

However, these sorting systems each suffer from one or more of requiring significant space, obstructing the flow of the herd, risking stressing and/or even hurting a livestock animal that closely follows the specific animal to be isolated, allowing only a single animal into the isolation area, having expensive, complex, and/or delicate construction and operation such as multi-component pneumatic piston systems to operate gates, etc.

It is further noted that US 2015/0233401 discloses a coupling device for releasable coupling of objects.

### SUMMARY

In view of the preceding considerations, herewith improved systems are provided.

In an aspect is provided a system for controlling movement of livestock animals, such as cows, from a first area to selective ones of plural target areas, comprising a sorting gate assembly for determining a path from the first area to a selective one of the target areas for a first livestock animal, and a separation gate assembly for reversibly blocking the path for a consecutive livestock animal. The sorting gate assembly is provided by first gate leaves of selectively lockable laterally opposite gates. The separation gate assembly is provided by second gate leaves of the gates moving together with the first leaf thereof and/or the separation gate assembly is configured to be operated by the first livestock animal for separating the first and consecutive animals.

The gates may be rotary gates, wherein the gate leaves are rotary about an axis of rotation. The rotary gates may swing in opposite directions, e.g. one gate rotating clockwise and the opposite gate rotating counter clockwise toward each other. The sorting gate assembly and/or the separation gate assembly may take the form of mitre gates, pointing in a direction along the path towards the target areas for facilitating opening in the direction towards the target areas. The gates may be lever gates.

In the system, and/or use thereof, determining a path from the first area to a selective one of the target areas may comprise selectively determining a first path from the first area to a first target area, and a second path from the first area to a second target area.

The presently provided system is simple and/or requires a small footprint. The sorting of the first animal to a selective one of the target areas can be done while simultaneously and automatically separating that first animal from the consecutive animal. Each of the areas (first area and any target area) can be of any desired type, e.g. an alley, an isolation area, a pasture, a stable, a milking parlor, a corral, a transport area, etc.

Laterally opposite gates, i.e. gates on opposite sides of a path for the animal so that an animal can pass between the respective gates, facilitate blocking a path and providing a path between the gates for the animal to follow, dependent on the position of the gates. The first gate leaves provide a sorting gate assembly and one or more second gate leaves moving together with a respective first gate leaf provide a separation gate assembly.

Selective locking of one or more of the gates, which also comprises selective unlocking one or more of the gates previously locked, allows providing different combinations of locked and/or unlocked gates (movable gates) and hence allows one or more of blocking, freeing, and defining at least part of one or more paths, reversibly.

Any two consecutive animals of two or more animals that are moving, or about to move, directly after each other through the gates from the first area to any one of the target areas along an associated path may be considered a respective first and consecutive animal for purposes of description and/or use of the system. Such two consecutive animals may also be referred to as a leading animal and a trailing animal. After the first animal has followed at least part of the path determined for it and has left the gate assembly, the consecutive animal may pass the second gate leaves providing a separation gate assembly and become a new “first animal”, a yet further animal moving directly after the latter animal then becoming a new “consecutive animal” as referred to herein. By appropriate determination of paths, a single animal or plural animals in succession may be directed to a particular target area and one or more subsequent animals may be directed to another target area; the system facilitates sorting and separating the respective animals.

The second gate leaves moving together with the first gate leaves, and/or configuring the separation gate assembly to be operated by the first livestock animal for separating the first and consecutive animals, allows the animals to accommodate their movement and separation together. This facilitates providing a natural and/or fast “flow” of the animals through the system, and/or it may one or more of reduce and/or prevent stress of the animals, reducing control operations, obviate control systems for monitoring and operating gates as a function of animal position and/or movement, reduce risks of injuring animals. The operation of the sorting gate assembly and/or separation gate assembly by the first animal may be inherent by the first animal actuating at least one of the second gate leaves.

The gates may selectively define one or more further paths to associated one or more further target areas.

The first and second gate leaves may be fixed to each other. Possibly, the first and second gate leaves form a unitary object.

Each gate may be rotary about an axis of rotation. The axes of rotation may be arranged on a line and/or in a plane substantially perpendicular to at least a portion of the paths at a location between the gates.

A lever gate comprises two or more gate leaves, here in particular at least the first and second gate leaves, rotary together about a lever axis extending in different directions about the lever axis. The lever axis may be defined by a hinge and/or other support. The lever axis may extend generally vertical so that each gate leaf rotates generally horizontally about the lever axis; a hinge and/or other support may be adjustable to adjust the lever axis to the vertical. A lever gate may be configured to rotate forth and back.

The first and second gate leaves may be at least partly parallel, e.g. extending in a plane, or may extend, at least in part, into nonparallel directions, e.g. extending to each other in a range of 90-150 degrees. The first and second gate leaves of a gate leaf may have the same or different shapes and/or sizes. Shapes and/or sizes of respective first and/or second gate leaves of the opposite gates may be the same or differ. The opposite gates may be shaped substantially symmetric. The opposite gates may be arranged symmetric about at least one of the areas (first area; first and/or second target area), the first path, and the second path.

At least part of the first area may be defined at least in part by and between the first gate leaves of the gates, in particular by and between the first and second gate leaves of the gates.

The system may comprise a controller for controlling locking of at least one of the gates; the control system may be provided with a user interface, and/or may be programmable for performing method steps comprising locking of at least one of the gates on the basis of a computer program, for which a memory may be provided in the controller and/or elsewhere in the system, and/or in a remote location e.g. on a server, such as a cloud server, possibly connected with the system via an Internet connection.

In the system, and/or use thereof, blocking the path for a consecutive livestock animal may comprise blocking the first and second paths from the first area, which may comprise confining the animal in the first area, and/or blocking entrance to the first area for the consecutive livestock animal. The blocking being reversible can be removed when the first animal has left the first area so that the consecutive animal can proceed, e.g. enter the first area, to be sorted to an appropriate one of the target areas.

In each gate the first gate leaf may be movable from a first position for blocking at least part of the first and second paths to a second position for defining at least one of the first and second paths, and the second gate leaf may then be configured to move with the first gate leaf from a third position associated with the first position to a fourth position associated with the second position. The first and second positions may then differ, and/or the third and fourth positions may then differ. In the first (fourth) position, a first (second) gate leave may close off a passageway for the animal(s). Also or alternatively, in the first (fourth) position of opposite first (second) gate leaves the gate leaves may contact each other, and/or they may cross and/or overlap each other, thus closing off a pathway for the animals.

At least one of the gates, preferably each of the opposite gates may comprise a gate leaf, in particular the first gate leaf, that, when the gate is unlocked, a livestock animal, such as a cow, can push out of its way in order to move along the selected one of the first and second paths. Thus, operation of at least part of the system may be performed by a livestock animal; in particular an animal selected to follow a particular path, such as an animal to be isolated. This may obviate provision of systems and/or external power for moving a gate or a gate leaf.

At least one of the gates may be configured for being urged to a default configuration and/or position, e.g. by gravity, and/or by comprising a resilient portion and/or an actuator to urge the first and/or second gate element to the default configuration and/or position.

The default configuration and/or position may be associated with blocking the first and second (and possibly further) paths by the first gate leaves, e.g. a “closed” position of the gate for sorting; the second gate leaves may then be in an unblocking position, allowing an animal to pass the second gate leaves and become the first animal as referred to herein. The resilient portion may be or comprise a (synthetic) rubber object and/or a metallic spring.

Use of gravity may obviate provision of a resilient portion and/or an actuator, simplifying construction and reducing operating costs. E.g., at least one of the gates may be biased with respect to an axis of rotation such as by comprising one gate leaf that is heavier than another gate leaf, and/or that defines a longer arm to the axis than another gate leaf. Gravity biasing may be provided and/or assisted by arranging the axis inclined to a vertical orientation. E.g. in at last one of the gates the first and/or second gate leaves may be rotary about an axis of rotation, wherein the axis of rotation may be vertical to within 15 degrees, preferably to within 10 degrees, more preferably to within 5 degrees, e.g. extending at about 3-10 degrees from vertical, preferably about 5-7 degrees from vertical; and/or the axis of rotation may be adjustably fixable between a first and a second angle to the vertical, e.g. at least part of a hinge and/or other support may be adjustable for that.

The first gate leaves of the opposite gates and/or the second gate leaves of the opposite gates may be configured for at least in part at least one of crossing, overlapping, and interleaving (with) each other for blocking a path for a livestock animal.

This may facilitate one or more of reducing real estate for the system, providing multiple options for defining paths, providing a greater barrier to the animals, and providing an impression of volume and/or strength of a barrier to the animals.

Crossing, and/or overlapping may be considered in a view generally perpendicular to the gates, in particular in a top view of the first and second paths; e.g. in a view generally parallel to lever axes of lever gates. Overlapping may mean that one gate leaf is hidden from view by another of the gate leaves in the respective view, the gate leaves extending in a common plane along and including the viewing direction; crossing then meaning that the gate leaves extend in different directions to each other so that in the respective view the gates are visible at least in part. Crossing, and/or overlapping may be provided by the first and/or second gate leaves being movable and/or offset from each other so that the respective gate leaves may at least partly pass each other between an open configuration and a close configuration of the gates. Possibly, the respective gate leaves may be at least partly vertically offset along the respective lever axis. Interleaving gates may be provided by first or second gate leaves having one or more teeth which may interleave with similar teeth of an opposite gate. Also or alternatively, a gate leave may be formed at least in part by one or more bars, which may be cantilevered.

The system may comprise one or more controllable magnet locks for the selective locking of one or more of the gates, in particular one or more electromagnetic locks.

A controllable magnet lock may comprise a first member comprising a controllable magnet, e.g. an electromagnet and/or a switchable permanent magnet, and an associated second member at least part of which is magnetically attractable to the first member for holding the first and second members in a defined relative position, preferably in mechanical contact, for locking. The second member may be at least partly magnetisable and/or magnetic (electromagnetic and/or permanently magnetic)—possibly also comprising a controllable magnet-, so as to be magnetically attractable by the first member. By controlling at least the magnetic field (strength and/or orientation) of the controllable magnet of at least the first member the magnetic attraction may be significantly reduced or removed, or be transformed into magnetic repulsion, for opening the lock.

Magnet locks, in particular based on electromagnets, may be reliably switched repeatedly and fast, and may require little volume, in particular in comparison with pneumatic and/or hydraulic locks customary in the field of sorting livestock.

An exemplary controllable electromagnet lock which may be used in any embodiment of a system disclosed herein may comprise a first lock member and an associated second lock member. The first lock member may comprise an electromagnet and a mounting for mounting to a support. The second lock member may comprise a base, an engagement member and a mounting for mounting to a support, in particular a portion of a gate (e.g. second gate leaf of a gate respectively). At least the engagement member may be attractable to (the magnet of) the first lock member for holding the first and second lock members in a defined relative position, in particular in physical contact of the engagement member and (optionally the electromagnet of) the first lock member. The attractive power of magnet locks may also be used to secure proper locking when the respective members are not, or not yet, in close (magnetic) contact so that alignment and positioning of the locking members may be improved.

The engagement member may be movably attached to the base. E.g. the engagement member is movably attached to the base via a universal coupling and a resilient element. The universal coupling may comprise an object movably retained in a receptacle of the base, e.g. being held rotary and/or translatably; such as a ball on a pedestal held in the receptacle and being retained in the latter by a narrowed opening. The resilient element may comprise a spring, e.g. a helical spring arranged around the pedestal. In other embodiments (not shown) a universal joint of different construction may be used, e.g. a resilient object such as a (possibly synthetic) rubber object. Thus, the lock can accommodate translational and/or rotational misalignment, and/or -impact of the respective first and second members and/or any support thereof, while allowing physical contact of the engagement member and (optionally the electromagnet of) the first lock member for optimum magnetic attachment and locking.

The system may comprise an alley for restricting passage by the livestock animals to single file to the gate assembly. Such alley assist providing the animals sequentially to the gate assembly. The first and/or second gate leaves may be configured to block the alley for livestock animals in at least one position.

The system may comprise an identification module for providing an identification signal associated with one or more of the animals, and a controller for controlling locking of at least one of the gates based on the identification signal.

Controlling the locking of the at least one of the gates based on the identification signal allows determining a path for the respective one or more of the animals, and it may comprise locking or unlocking one or more of the gates. Thus, the identification module and controller allow sorting an identified animal to a particular target area.

The identification module may comprise one or more detectors for identifying an animal based on one or more properties of the animal itself, e.g. such as one or more of size, skin properties (e.g. colouring, pattering, scarring, etc.) weight, gait, motility, temperature, etc. E.g. the detector may comprise one or more cameras, invisible radiation detectors, scales, thermometers, etc. Suitable techniques may comprise LIDAR detection and/or -imaging. Suitable imaging techniques may comprise 2D and/or 3D imaging, and/or time-dependent imaging; identification may be based on animal movement properties like gait, and/or one or more behavioural patterns. Also or alternatively, the identification module may comprise one or more detectors such as one or more detectors for identifying an animal based on one or more properties of one or more objects associated with the animal, e.g. one or more objects worn by the animal such as bells, ear marks, collars, leg rings, transponders, etc. which objects may or may not comprise an antenna, an integrated electronic circuit, etc. An identification module may therefore comprise one or more of contact detectors and/or non-contact detectors. Non-contact detectors may comprise optical detectors (e.g. using (near) ultraviolet radiation, and/or human-visible light, and/or (near) infrared radiation, e.g. in a wavelength range 300 nm-2.5 micrometres, visible light being in a wavelength range 400 nm-700 nm), and/or non-optic electromagnetic detectors such as relying on electromagnetic signals in radio frequency bands (e.g. RFID, Bluetooth, WiFi, etc.), and/or acoustic signals (e.g. ultrasound).

The identification module may comprise a controller to determine the identification signal based on one or more signals from the detector(s) and on one or more of selection criteria and/or animal data. The selection criteria and/or animal data may be stored in and/or provided to the identification module from a user interface and/or from a memory, e.g. a lookup table. Also of alternatively, a localisation device such as a barrier crossing detector (such as e.g. light source and optical detector on opposite sides of an alley), a proximity sensor, and/or an animal-operable device may be provided for assisting determination of an appropriate timing for locking and/or unlocking and/or re-locking a gate in dependency of an animal's presence, absence, and/or movement relative to a gate assembly of the system.

The controller may be directly connected with the identification module, wirelessly connected, and/or remotely connected with it, e.g. via an Internet connection.

Also, herein is provided a method for controlling movement of livestock animals, such as cows, from a first area to selective ones of plural target areas, comprising providing a plurality of the livestock animals, a system as provided herein according to any preceding claim, selecting a target area for a first livestock animal, and controlling locking of the gates of the system to determine a path from the first area to the selected target area for the first livestock animal by selectively allowing movement of one or more first gate leaves of each gate. Selecting a target area for the first livestock animal may comprise identifying at least one property of the first animal and selecting the target area on the basis of the determined property of the animal.

As explained above, compared to known systems, the method may simplify and/or accelerate sorting; also or alternatively the method may require less space, compared to current methods.

The method may comprise determining a path from the first area to a selective one of the target areas which may comprise selectively determining a first path from the first area to a first target area or a second path from the first area to a second target area.

The method may comprise reversibly blocking the path for a consecutive livestock animal, which may comprise blocking entrance to the first area for the next livestock animal and/or blocking the first and second paths for the next livestock animal when the first animal is in the first area and removing the block when the first animal is out of the first area.

The method may comprise identifying a livestock animal and selectively lock and/or unlock at least one of the gate leaves for allowing the animal to pass from the first area to the selected target area.

The method may comprise identifying a livestock animal and selectively lock and/or unlock at least one of the gate leaves for allowing the animal to pass from the first area to the selected target area.

The method may comprise allowing and/or urging the animal to push at least one gate leaf of the system out of its way in order to move along the selected one of the first and second paths.

As explained herein, herewith is provided a system for controlling movement of livestock animals, such as cows, from a first area to selective ones of plural target areas, comprising a gate assembly comprising selectively lockable laterally opposite gates, in particular lever gates, for selectively determining a path from the first area to one of the target areas for a first livestock animal by a first gate leaf of each gate, and blocking the path for a consecutive livestock animal by a second gate leaf of at least one of the gates moving together with the first leaf thereof. Further, various beneficial features of and for it are provided.

The provided system may be designed to be integrated into an alley in which the animals, e.g. cows pass through. The animals that are selected to be sorted may be guided to the left or the right (or: left, right or centre), for example to a holding area or a parallel alley.

The system may comprise locking/opening of gates using (preferably powerful) electro-magnets. There may be two gates that can be locked in a closed position by these electro-magnets. The animals may be sorted by always ensuring that one of the gates is unlocked, and the animal that is in a separating/sorting area between the gates at some point in time may push that gate open to move in the desired direction. The electro-magnets allow for easy locking and opening of the gates, e.g. because precise timing of a mechanical latch or lock is not required. The magnet can be turned on prior to closing of the gate, and the next time the gate closes it will be locked in place instantly.

Also or alternatively, in the system the opposite gates also act as a separation mechanism. As an animal moves through either of the gates, the pushing open of the gate by the animal will swing it around an axis of rotation or other fulcrum, the counter swinging component of the gate closes the alley behind the animal such that the consecutive animal cannot move into the separation/sorting area until the previous animal has left, and the gate has swung (or been pushed by the following animal) into the closed position again. At such point, with both gates in a closed position, a decision can be made which gates to lock and unlock for the next animal in the queue.

Also or alternatively, the system can be configured to sort the animals into three different directions, with two gates starting in a default closed position and allowing the opposite gates to move to a position to allow the animals to move straight on where the gates may be locked in position by a secondary locking mechanism, or to allow only one gate to swing open to either allow the animal to move to the left or the right directions. Again in all three positions, straight, left and right, one or both of the gates opening closes the path behind for the following animal.

Also, in an aspect, a system for controlling movement of livestock animals, such as cows, from a first area to selective ones of plural target areas, is provided, comprising a gate assembly comprising selectively lockable laterally opposite gates for defining a first path from the first area to a first target area and a second path from the first area to a second target area for a first livestock animal by a first gate leaf of each gate, wherein at least one of the gates, preferably each of the opposite gates comprises a gate leaf, in particular the first gate leaf, that, when the gate is unlocked, a livestock animal, such as a cow, can push out of its way in order to move along the selected one of the first and second paths.

Such system may or may not be also configured for blocking the first and second paths for a consecutive livestock animal by a second gate leaf of at least one of the gates moving with the first leaf thereof, e.g. the at least one of the gates or each of the opposite gates being a lever gate.

Any other feature of systems disclosed herein may be suitably combined with a system of this aspect; in particular, such system may comprise one or more controllable magnet locks for the selective locking of one or more of the gates, in particular one or more electromagnet locks such as discussed herein elsewhere.

Any embodiment of a system provided herein, in particular a gate, may be partly or mostly constructed from rod- and/or pipe material, which may be of a metal, e.g. (possibly welded) steel pipes. A foundation of the system for use with cows as the livestock animals may be based on, and/or provided by, an alley around 1 meter wide; for other livestock animals other sizes may be suitable.

In a system, one side of the alley may have an opening into which a first gate leaf as a swinging component of a gate will be able to open and allow animals to pass into a holding area or parallel alley, as exemplary target areas. The opening may be about two meters long as an example.

The alley can be defined or made at least in part of a solid wall and/or steel piping, but a space should be provided on the alley wall on an appropriate side of a gate for the second gate leaf as a counter swinging component to move outside of the alley.

The gates may be mounted on simple rotary hinges. These hinges can be angled in such a manner that the asymmetrical weight distribution of the gates causes them both to “fall” to the closed position. Having the gates fall to the closed position is beneficial for the flow rate of the animals moving through the system, as otherwise the closing of the gate is completely reliant on the animals to apply force to the counter swinging component to move it out of the alley. Another useful addition may be to make use self-closing rising hinges or returning springs.

In general the steel structure, gates, hinges and mountings for the technical items discussed below should preferably be exceeding strong and durable. When large animals such as cows move through the gate system, moving the gates with their own bodyweight and momentum, the forces applied may be quite large.

Electro-magnet locks may be used for one or more system embodiments. In particular, the second gate leaves may be provided with steel plates, e.g. attached to the very ends of counter-swinging arms of the gates as the second gate leaves, steel plates may be provided. Such steel plates may line up with powerful electromagnets which may be similar to the types typically seen on security doors. These electro-magnets may e.g. have a hold force of 5 kN or more, e.g. in a range of 8-15 kN. When a gate is to be locked, the electro-magnets may be energized, such energization may be done with a low- or medium-power, e.g. a 24V power supply. The energization may be done using a suitable switching arrangement e.g. by triggering a relay switch. Once the magnet of a lock has been energized it will lock the gate at the next moment it is closed, regardless of how fast or with how much force the gate is slammed shut for closing. An electro-magnet may be formed as a copper coil wrapped around a mass of ferromagnetic iron or steel, such magnet (and a lock formed with such magnet) may withstand high energy impacts from the steel plate. An electromagnet lock may comprise one or more such magnets.

The mounting arrangement of the electro-magnets should preferably be able to support a pulling force exceeding the holding force of the electro-magnets themselves and likewise be able to withstand the force of impacts transferred through the magnets by the slamming shut of the gates.

An element such as a steel plate that is (to be) “grabbed” by the magnetic member of the magnet lock should preferably have a surface area significantly larger than the magnet itself, and/or or a magnetisable portion of a lock member comprising the magnet, such that potential misalignment or play in the hinge of the gate is not reduced or prevented from causing the plate to have full contact with the magnet, which could otherwise weaken the holding force of the magnet onto the plate and thus the holding force of the lock. It might also be beneficial to mount the steel plate to the gates in such a manner that the plates can rotate and/or flex in plural directions, to allow for misalignment or bending of the gates.

Given the livestock environment in which the system may be intended to be used, it may be desired to protect the electro-magnets and steel plates from contact with substances like dirt, urine, and/or manure. The attractive range of most electro-magnets may be on the order of a few centimetres, and full holding strength is generally only achieved when the plate or other locking contact member is in direct contact with the magnet or a magnetic field guide associated with the magnet, if so provided. Even a separation by a comparably thin layer of manure on the order of one or few mm could significantly reduce the holding strength of the magnet lock. Mounting a cover such as a protective box around the magnetic lock member such that the plate moves into a covered space to find the magnet could protect somewhat from contamination. Reducing a possible amount of manure and/or its effects could also be achieved by a brush or curtain that would clean the steel plate as it swings by.

At least part of any system provided herein may comprise automated control of the controllable locks, e.g. locking electro-magnets, which control may be based on detection, e.g. RFID detection, of animal identity. E.g. a memory could hold a lookup table with animal data, e.g. a list of animals to be isolated from the herd provided by the user and/or automatically generated by an animal management system. Upon identification of the animal entering or about to enter the sorting area, a trigger signal may be given by a controller provided and/or connected with the memory to the lock associated with the relevant gate, for locking a gate where the animal is not allowed the pass through and/or unlocking a gate which the animal should pass.

### BRIEF DESCRIPTION OF THE DRAWINGS

The above-described aspects will hereafter be more explained with further details and benefits with reference to the drawings showing a number of embodiments by way of example.

FIGS. 1-7 schematically show, in top view, a first system for controlling movement of livestock animals in different configurations;

FIGS. 3-12B schematically show, in different views and configurations, a second system for controlling movement of livestock animals;

FIGS. 13-17 schematically show a third system for controlling movement of livestock animals in different configurations.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes.

Further, unless otherwise specified, terms like “detachable” and “removably connected” are intended to mean that respective parts may be disconnected essentially without damage or destruction of either part, e.g. excluding structures in which the parts are integral (e.g. welded or moulded as one piece), but including structures in which parts are attached by or as mated connectors, fasteners, releasable self-fastening features, etc. The verb “to facilitate” is intended to mean “to make easier and/or less complicated”, rather than “to enable”.

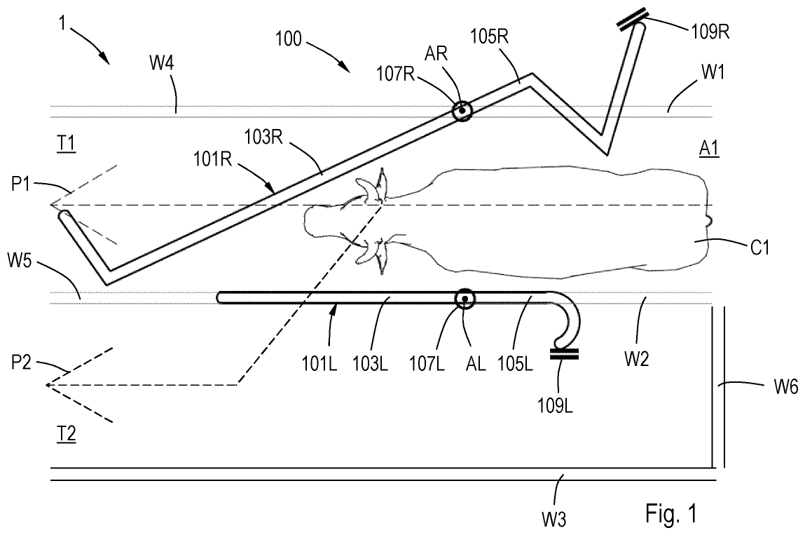

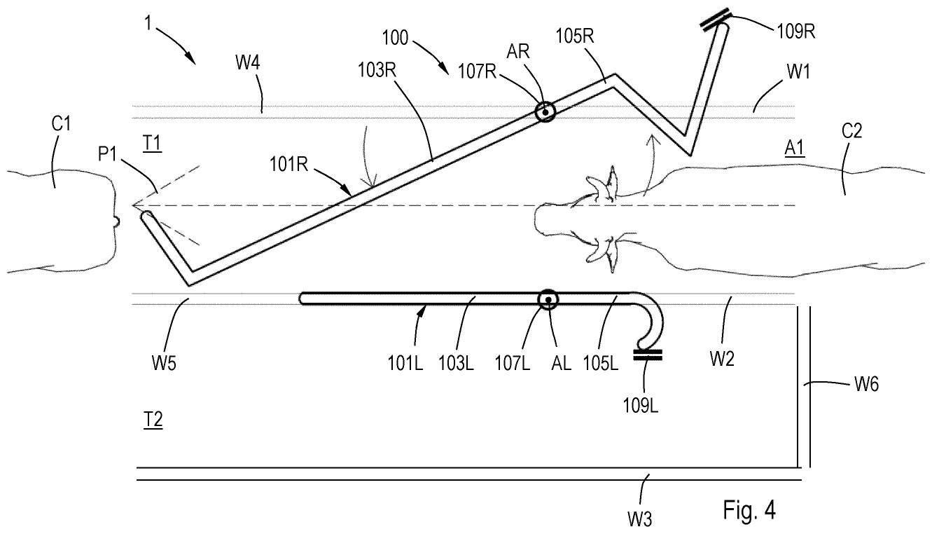

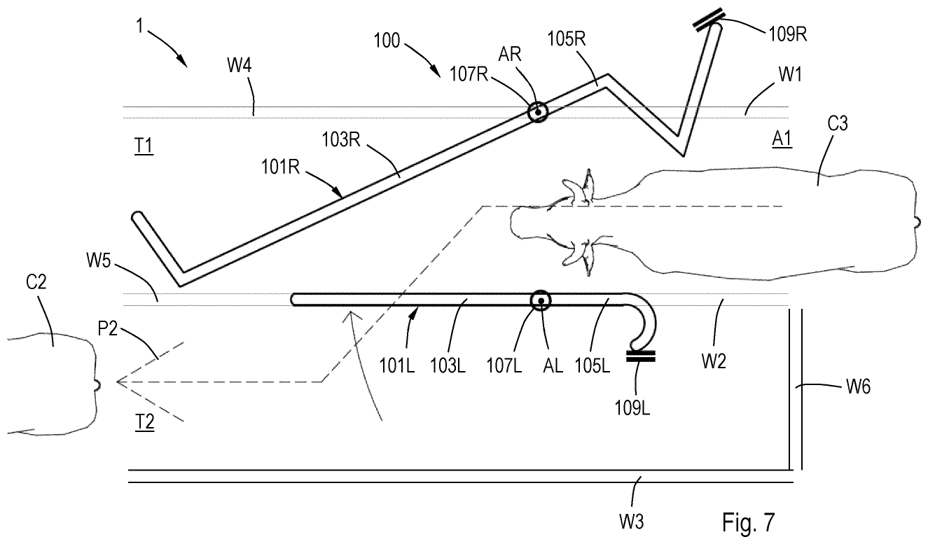

FIGS. 1-7 schematically show, in top view, as a first embodiment a system 1 for controlling movement of livestock animals C1, C2, such as cows, from a first area A1 to selective ones of a first target area T1 and a second target area T2. The system 1 comprises a gate assembly 100. Here, the first area A1 and the first and second target areas T1, T2 are defined in part by boundaries such as walls W1-W6 which may be of any suitable construction. The first area A1 is formed at least in part by an alley defined by walls W1, W2 for restricting passage by the animals C1, C2 to single file in the alley to the gate assembly 100.

The gate assembly 100 comprises a first gate 101R, and a second gate 101R. Each gate 101R, 101L is comprises a first gate leaf 103R, 103L and a second gate leaf 105R, 105L and is rotary about a respective axis of rotation AR, AL defined by a respective hinge 107R, 107L. Here, each gate 101R, 101L is formed as a lever gate with the axis of rotation AR, AL forming a respective lever axis. The respective first and second gate leaves 103R, 105R; 103L, 105L, of each gate 101R, 101L form, as an option a respective unitary object. The respective first and second gate leaves 103R, 105R; 103L, 105L, of each gate 101R, 101L extend generally in opposite directions about the respective axis of rotation AR, AL. In the shown embodiment, each gate 101R, 101L, i.e. the first gate leaves 103L, 103R and second gate leaves 105R, 105L, rotates generally horizontally about the respective axis of rotation AR, AL.

The system 1 further comprises controllable locks, e.g. controllable electromagnet locks 109R, 109L, for selective locking of each respective gate 101R, 101L in a first configuration, seen in FIG. 1, by attracting at least part of the respective gates 101R, 101L, here the second gate leaf 105R, 1051 thereof.

In the first configuration shown in FIG. 1, (the first gate leaf 103R of) the first gate 101R blocks a path P1 from the first area A1 to the first target area T1. Also in the first configuration, (the first gate leaf 103L) the second gate 101L blocks a path P2 from the first area A1 to the second target area T2, here by extending generally between and along the walls W2 and W5 providing a largely continuous boundary.

In the first configuration, the second gate leaves 105R, 105L of the first and second gates 101R, 101L allow passage of a first animal C1 between part of the gates 101R, 101L to enter a sorting area between the first and second gates 101R, 101L.

The hinges 107R, 107L may be of the same or of different construction. As an example, the axis of rotation AR of the first gate 101R may be inclined to a vertical orientation and the first gate leaf 103R is significantly longer and possibly heavier with respect to the axis of rotation AR than the second gate leaf 105R, so that the first gate 101R is urged by gravity to the position shown in FIG. 1 providing a default configuration. As another example, the axis of rotation AL of the second gate 101L is generally vertical but the hinge 107L formed such that upon rotation of the gate 101L about the axis AL, from the configuration shown in FIG. 1, the gate 101L is raised, e.g. by cooperating inclined surfaces, such that upon release the gate 101L is urged by gravity back to the shown first configuration.

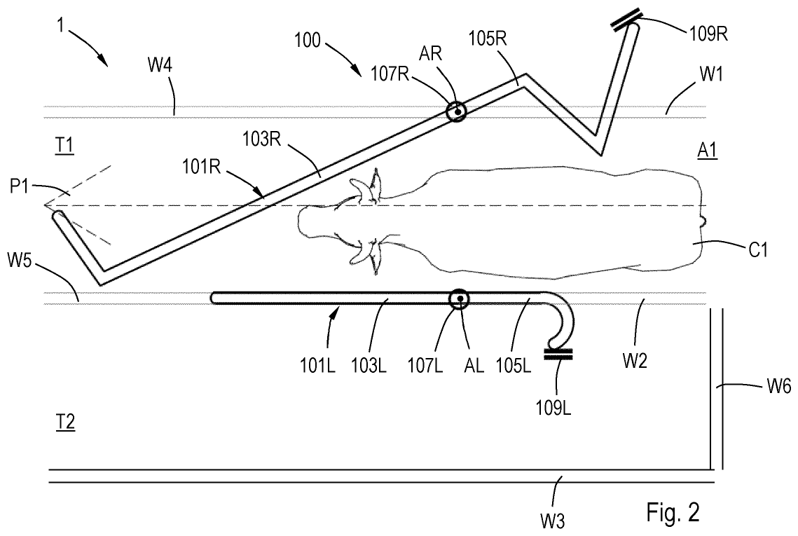

FIGS. 2-4 show that, starting from the first configuration, by selective unlocking of the first gate 101R (and maintaining the second gate 101L locked) rotation of the respective unlocked gate 101R about its axis of rotation AR is allowed and a first path P1 from the first area A1 to a first target area T1 is determined for the first animal C1. By keeping the second gate 101L closed, a path to the second target area T2 is still blocked for the first animal C1.

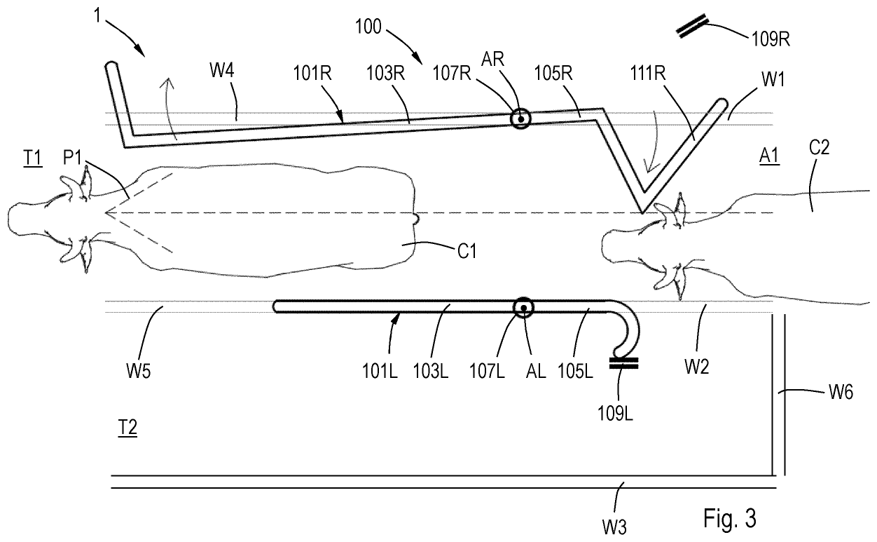

The first gate 101R could be operated by a person and/or an actuator, but preferably it is configured such that when the gate is unlocked the animal C1 can push the first gate leaf 103R out of its way in order to move along the first path P1, see FIGS. 2-3. Best seen in FIG. 3, together with moving the first gate leaf 103R for allowing the first animal to pass along the path P1, the second gate leaf 105R is moved and is rotated into the alley blocking the path P1 for a consecutive animal C2.

The blocking is assisted by the second gate leaf 105R being provided with a portion extending nonparallel to the first gate leaf 103R so as to constrict the path P1 to a width narrower than a characteristic size of the animals, e.g. a head- and/or shoulder width. Thus first and the consecutive animals C1, C2 are longitudinally separated and the consecutive animal C2 cannot follow the first animal C1 along the path P1, and in particular the consecutive animal C2 cannot enter a sorting area between the gates 101R, 101L. This improves “natural flow” of animals through the gates.

Once the first animal C1 moves into the first target area T1 the gate 101R may return to the default configuration, e.g. since the first animal no longer engages and pushes the first gate leaf 103R away. Thus the second gate leaves 105R 105L again allow passage, now of the consecutive animal C2, between part of the gates 101R, 101L to enter a sorting area between the first and second gates 101R, 101L. This return of the second gate leaf 105R may be assisted by the consecutive animal C2 pushing the second gate leaf 105R out of its way, for which at least part 111R of the second gate leaf 105R may bend outward relative to the axis AR. Then, the consecutive animal C2 may pass the second gate leaves 105R.

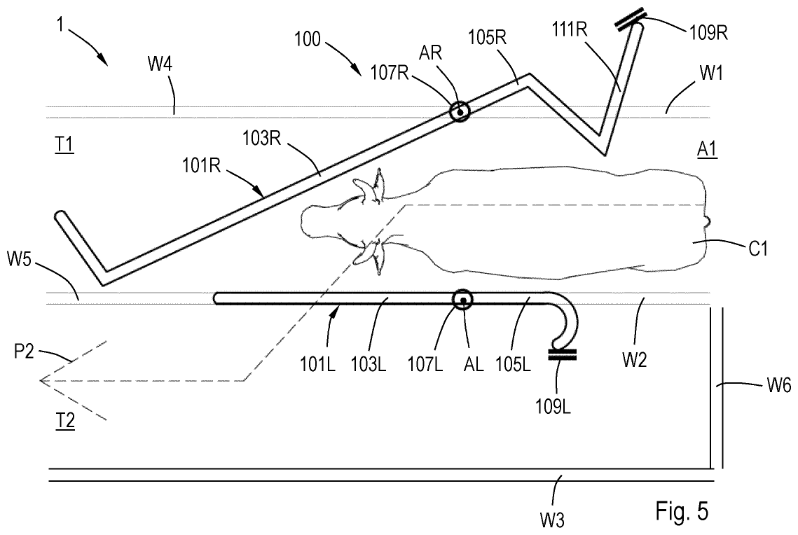

FIGS. 5-7 show that, starting from the first configuration, by selective unlocking of the second gate 101L (and maintaining the first gate 101R locked) rotation of the respective unlocked gate 101L about its axis of rotation AL is allowed and a second path P2 from the first area A1 to a second target area T2 is determined for the second, consecutive animal C2. By keeping the first gate 101R now closed, a path to the first target area T1 is blocked for the consecutive animal C2.

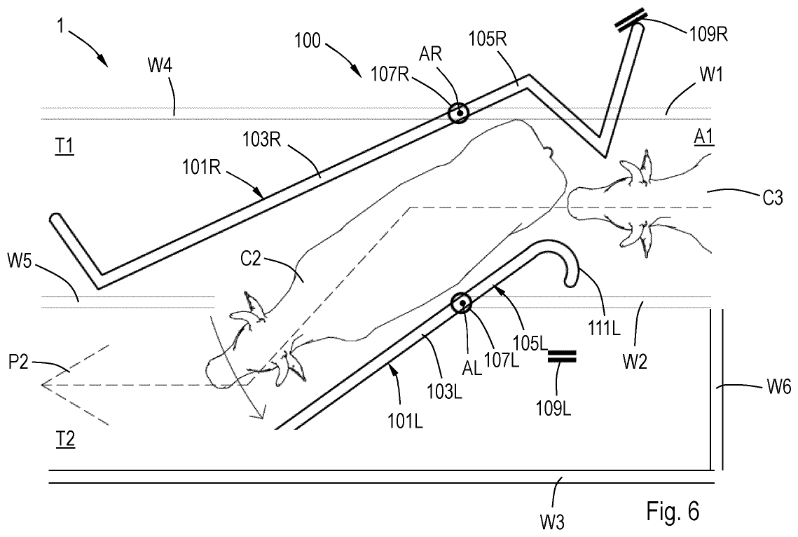

The second gate 101L could be operated by a person and/or an actuator, but preferably it is configured such that when the gate 101L is unlocked the animal C2 can push the first gate leaf 103L of the second gate 1010L out of its way in order to move along the second path P2, see FIGS. 5-6. Best seen in FIG. 6, together with moving the first gate leaf 103L for allowing the animal C2 to pass along the path P2, the second gate leaf 105L is moved and is rotated into the alley blocking the path P2 for a next animal C3.

The blocking is assisted by the second gate leaf 105L being provided with a portion extending nonparallel to the first gate leaf 103L so as to constrict the path P2 to a width narrower than a characteristic size of the animals, e.g. a head and/or shoulder width. Thus animal C2 and a second consecutive animal C3 are longitudinally separated and the second consecutive animal C3 cannot follow the first consecutive animal C2 along the path P2, and in particular the second consecutive animal C3 cannot enter a sorting area between the gates 101R, 101L.

Once the animal C2 moves into the second target area T2 the gate 101L may return to the default configuration, e.g. since the animal C2 no longer engages and pushes the first gate leaf 103R away. Thus the second gate leaves 105R, 105L again allow passage, now of the second consecutive animal C3, between part of the gates 101R, 101L to enter a sorting area between the first and second gates 101R, 101L. This return of the second gate leaf 105L may be assisted by the second consecutive animal C3 pushing the second gate leaf 105L out of its way, for which at least part 111L of the second gate leaf 105L may bend outward relative to the axis AL.

Thus, the first gate leaves 103R, 103L of the first and second gates 101R, 101L provide a sorting gate assembly for determining a path from the first area to a selective one of the target areas for a first livestock animal C1. The second gate leaves 105R, 105L of the first and second gates 101R, 101L provide a separation gate assembly for blocking the path for a consecutive livestock animal C2.

Selecting a path P1, P2 for an animal may be done by identification of the animal for which an identification module may be provided (not shown).

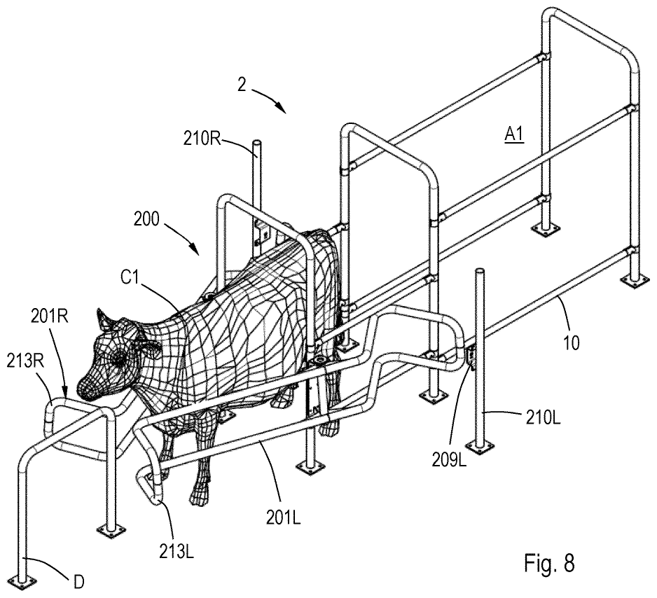

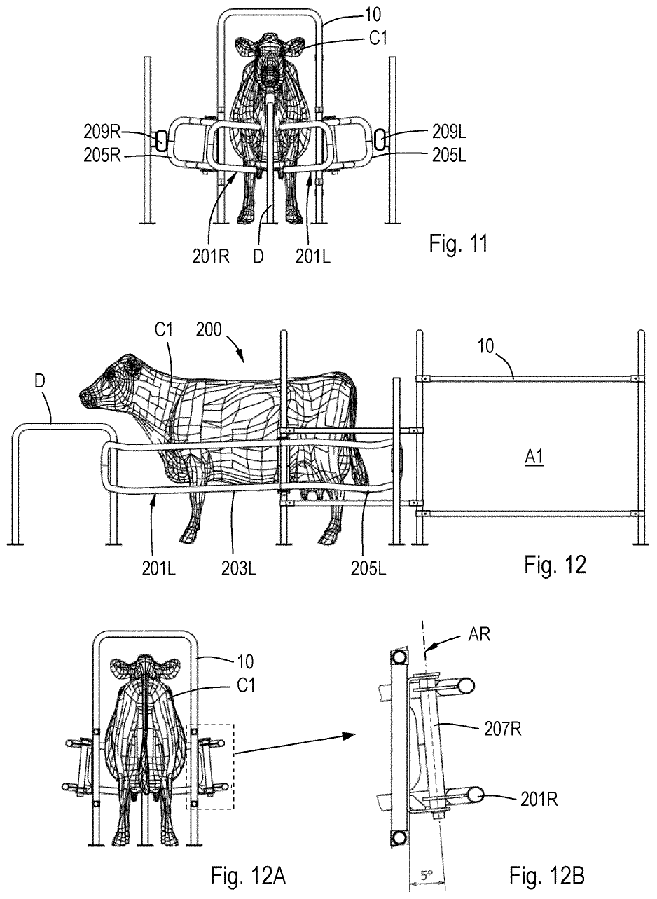

FIGS. 8-12 show in various views another embodiment of a system 2 as provided herein, for two-way sorting of livestock animals; FIG. 12B shows a detail of FIG. 12A. The present system 2 may be generally left/right symmetric.

The system 2 comprises a gate assembly 200 comprising selectively lockable laterally opposite first and second gates 201R, 201L, each comprising a first gate leaf 203R, 203L and a second gate leaf 205R, 205L rotary about a respective axis of rotation AR, AL defined by a respective hinge 207R, 207L. The hinges are arranged generally in a plane perpendicular to the alley providing first area A1. Here, each gate 201R, 201L is formed as a lever gate with the axis of rotation AR, AL forming a respective lever axis. The axes AR, AL are as an option inclined to the vertical; by about 5 degrees (FIG. 12B) for gravitational biasing toward a default position for a closed configuration of the gates, as shown; the first gate leaf 203R, 203L of each gate rotating clockwise (203L) or counter clockwise (203R) respectively, in top view, for the closed configuration. As indicated, the first gate leaves 203R, 203L may be longer than the width of alley and provide a mitre gate arrangement pointing in a direction along the path towards the target areas. The system 2 comprises controllable locks, e.g. controllable electromagnet locks 209R, 209L, for selectively locking the gates 201R, 201L in or near the respective default positions. Schematically indicated is that a first member of one or each locks 209R, 209L may be supported on a support 210R, 210L, optionally a dedicated support; an optional second member of a lock may be provided on a gate.

The system 2 further comprises a divider D as a boundary separating a first and a second target area T1, T2 (further boundaries of first and a second target areas T1, T2 not shown). Here, the divider D is arranged substantially symmetric to the alley providing the first area A1. The first and second gates 201R, 201L close to the divider D in the respective default positions; the first gate leaves 203R, 203L may engage each other and/or the divider D (not shown) and possibly be locked (also) at or near such engagement portions. The first gate leaves 203R, 203L are as an option provided with flared ends 213R, 213L for one or more of providing a visual cue to the animals, facilitating contact between the gate and the animal, preventing harming the animals, preventing snagging onto an animal.

Further, the system 2 comprises an optional portal 10. The portal 10 defines as, or as part of, the first area A1 an alley for restricting the animals to a single file. The first and second gates 201R, 201L may be mounted to the portal 10, as shown.

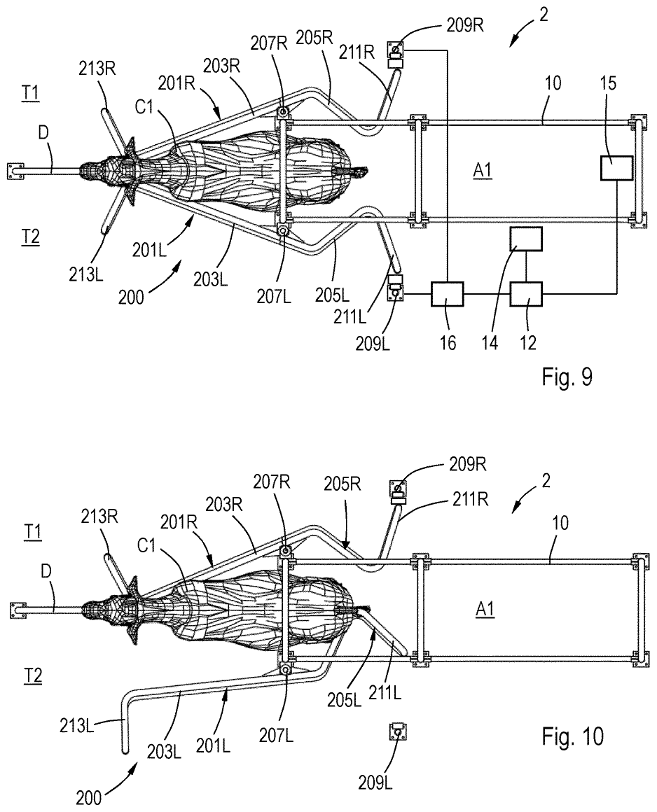

Also, as schematically indicated only in FIG. 9, the portal 10 may support and/or be provided with at last part of an identification module 12 for providing an identification signal associated with one or more of the animals, e.g. one or more sensors 14, 15 such as cameras, RFID detectors, etc. Further a controller 16 may be provided connected with the identification module 12 for controlling locking of at least one of the gates 201R, 201L based on the identification signal, e.g. being connected with the controllable locks 209R, 209L

FIGS. 9, 10, 10A-10B show that selective locking of lock 209R and unlocking of lock 209L, allows opening of one of the gate 201L thus determining a path for the animal C1 from the first area A1 to the second target area T2. The same applies for the other gate 201R and target area T1, mutatis mutandis, as clear from FIGS. 9, 10A and 10C.

From FIGS. 10B and 10C also is clear that the second gate leaves of each gate serve to block entrance for the consecutive animal C2 to the area defined between the first and second gate leaves. Thus, (the second gate leaves of) the opposite gates also act as a separation mechanism.

In the system, one or each gate may be configured such that, the first gate leaf is movable from a first position for blocking at least part of the first and second paths (FIGS. 9, 10A), to a second position (FIGS. 10, 10B; FIG. 10C) for defining at least one of the first and second paths, and the second gate leaf is configured to move with the first gate leaf from a third position (FIGS. 9, 10A), associated with the first position to a fourth position (FIGS. 10, 10B; FIG. 10C) associated with the second position. The gates may be formed so that in the latter position the second gate leaf extends past a midplane of an alley associated with the system and/or being part of the system, e.g. an alley for restricting the animals to a single file and being associated with an identification system, or another relevant position, so as to block the consecutive animal from passing the separation gate assembly.

Best seen in FIGS. 10, 10A, each gate may have a length substantially equal to that of an animal to be sorted, taken along a length direction of the path.

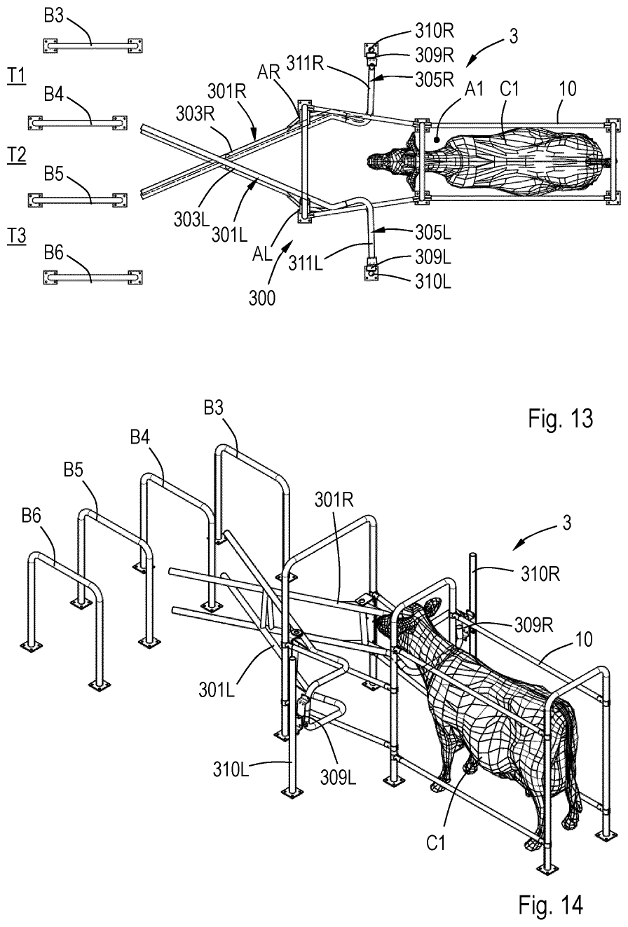

FIGS. 13-17 show, in top view and perspective view, respectively, a further embodiment 3 of a system provided herein, for three-way sorting of animals.

Like the embodiment 2, the system 3 comprises a first area A1, and plural target areas, here first, second and third target areas T1, T2, T3 defined at least in part by boundaries B1-B6. The system 3 also comprises a gate assembly 300.

The gate assembly 300 comprises selectively lockable laterally opposite first and second gates 301R, 301L, each comprising a first gate leaf 303R, 303L and a second gate leaf 305R, 305L rotary about a respective axis of rotation AR, AL defined by a respective hinge 307R, 307L. Here, again each gate 301R, 301L is formed as a lever gate with the axis of rotation AR, AL forming a respective lever axis. The axes AR, AL may be formed for gravitational biasing toward a default position for a closed configuration of the gates, as shown in FIGS. 13-14. Like in system 2, the gates may be formed by steel bars or pipes, as shown. In the closed configuration, the gates 301R, 301L as an option at least partly cross and/or overlap, here at least in top view, here by a vertical offset of at least part of the first gate leaves 303R, 303L, as visible in FIG. 14. Thus, (the first gate leaves 303R, 303L of) the gates 301R, 303L form overlapping and/or interleaving mitre gates. Thus, (the first gate leaves 303R, 303L of) the gates 301R, 303L close the first area A1 off and block all paths to the target areas T1-T3. When unlocked, the first and second gates 301R, 301L may be moved by an animal C1 pushing the respective gate out of its way therewith blocking paths for a consecutive animal C2 (see also below).

The system 3 comprises controllable locks 309R, 309L, e.g. controllable electromagnet locks 309R, 309L, for selectively locking the gates 301R, 301L in or near the respective default positions (FIG. 13). Like in the other embodiments, paths P1-P3 from the first area A1 to respective ones of the first, second and third target areas T1, T2, T3 may be defined by suitably (un) locking and arranging the first and second gates 301R, 301L, and/or allowing such arrangement by an animal's action. The system 3 may also comprise second controllable locks 319R, 319L (only indicated in FIGS. 13 and 16) facilitating and/or determining such arrangement. Construction of one or more of the various locks 309R, 309L; 319R, 319L may be the same or different. E.g., the second controllable locks may comprise blocking bars that are pneumatically or, preferably, electromagnetically actuatable for (un) blocking (further) rotation of a gate leaf. Note that more, less, and/or differently positioned locks may be provided in this and/or in any other embodiment for determining positions of the respective gate leaves for determining (parts of) paths and/or areas. E.g. in system 3 the first gate leaves 303R, 303L may obviate some boundaries between different areas as shown.

FIGS. 13-14 show the gates defaulted to the closed position, the first gate leaves 301R, 301L forming a sorting gate assembly blocking paths for a first animal C1 to any target area T1-T3, but allowing the animal to pass the second gate leaves 30R, 305L providing a separating gate assembly.

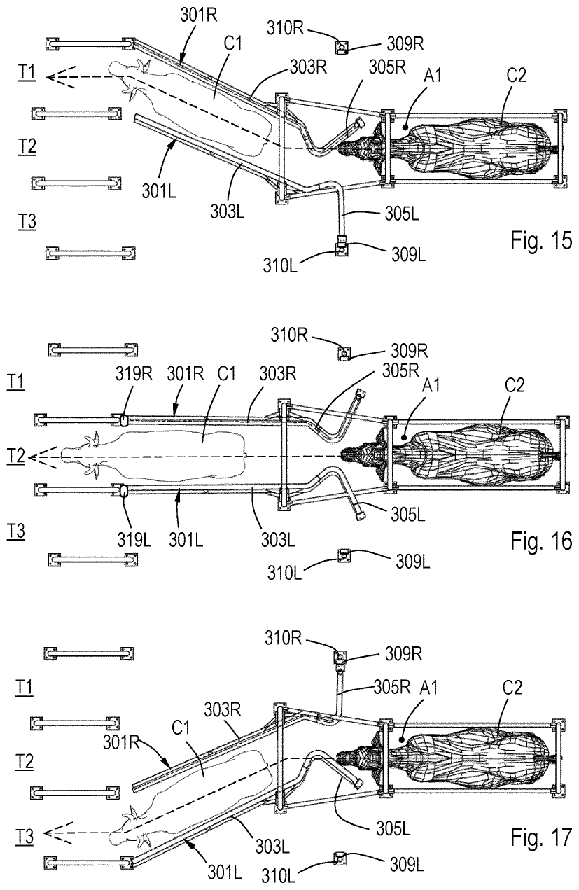

FIGS. 13-14 and 15 show that, like in the embodiments discussed before, locking lock 309L and unlocking locks 309R, 313R, 319L allows moving the first gate leaf 303R of the first gate 301R from a first position, providing the closed configuration (FIGS. 13-14) to a second position, providing an open configuration (FIG. 15), while the other gate 301L remains in locked in place; thus part of a path P1 for the animal C1 to follow from the first area A1 to the first target area T1 is defined and made available to the animal. Also together with the movement of the first gate leaf 303R the second gate leaf 305R of the first gate 301R moves from a third position allowing entrance of the first animal C1 into a sorting area S between the opposite gates 301R, 301L to a fourth position blocking the consecutive animal C2 (FIG. 15).

FIGS. 13-14 and 17 show, that the same applies, mutatis mutandis, for the other gate 301R to determine and make available part of a path P3 for the first animal C1 from the first area A1 to the third target area T3 and blocking the path for the consecutive animal C2 by selective locking and unlocking of the locks 309R, and, respectively, 309L, 319R, and 319L.

FIG. 16 show that, if the animal C1 is to be sent to the second target area T2, path P2 (straight) is (to be) determined and opened to the animal. For that, starting from the closed configuration (FIG. 13-14) both locks 309R, 309L are unlocked (e.g. electromagnet locks being de-energized) and the animal C1 may push open the first gate leaves 303R, 303L of both gates 301R, 301L. The open position may be defined and maintained by selectively locking the gates 301R, 301L with the optional associated second controllable locks 319R, 319L; note that second controllable locks for locking the first gate leaves 303R, 303L of both gates 301R, 301L to determine such path P2 may be arranged in other positions than the ones shown. Together with the moving of the first gate leaves 303R, 303L, the second gate leaves 305R, 305L block the path for a consecutive animal C2 in an alley leading up to the gate assembly 300, which may be provided at least as long as the gates are kept in such position by the first animal C1 remaining at least partly between the first gate leaves 303R, 303L and/or by locking of the second controllable locks 319R, 319L; thereafter the gates 301R, 301L may return to the closed configuration (FIG. 13-14) as their default position, which return may be assisted by the consecutive animal C2 pushing the second gate leaves 305R, 305L apart and out of its way.

In another embodiment, not shown, the second gate leaves may be arranged to at least partly cross and/or overlap each other so as to block the consecutive animal from passing the separation gate assembly provided by the second gate leaves (FIG. 16), which separation gate assembly may also comprise part of the alley and/or detector portal 10 to provide a width narrower than a characteristic size of the animals, e.g. a head- and/or shoulder width. Herd animals, in particular cows, tend to learn, and get used to, embodiments of the provided system and method, and operation thereof, very quickly and easily without apparent stress, in particular in case of gate leaves that the animal(s) can push out of the way.

The disclosure is not restricted to the above described embodiments which can be varied in a number of ways within the scope of the claims. E.g. more and/or differently arranged target areas, e.g. four or five, may be provided.

As may be understood from all Figs, in particular FIGS. 10-19, a first animal may be identified just before, at or even after the passing the separation gate assembly provided by the second gate leaves and then a desired path for the animal may be determined and provided for and to the animal by switching the respective locks. Also, when the gates are appropriately dimensioned, then in case a first animal is in the sorting area defined between the first and second gate leaves, a consecutive animal cannot also enter that area, and the first animal cannot proceed when the subsequent animal stays at the location of the separation gates. Thus, separation and localisation of the animals, and therewith identification and path-control of the animals is facilitated. In a control system, this may obviate queuing and/or administrative tasks for tracking animals and/or controlling gates.

Various embodiments may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

Elements and aspects discussed for or in relation with a particular embodiment may be suitably combined with elements and aspects of other embodiments, unless explicitly stated otherwise.

1. A system for controlling movement of livestock animals from a first area to selective ones of plural target areas the system comprising
a sorting gate assembly for determining a path from the first area to a selective one of the plural target areas for a first livestock animal, and
a separation gate assembly for reversibly blocking the path for a consecutive livestock animal;
wherein the sorting gate assembly is provided by one or more first gate leaves of one or more selectively lockable laterally opposite lever gates, and
the separation gate assembly is provided by one or more second gate leaves of the selectively lockable laterally opposite lever gates moving together with the one or more first gate leaves of the sorting gate assembly and/or the separation gate assembly is configured to be operated by the first livestock animal for separating the first and consecutive animals.

2. The system according to claim 1, configured for:
determining the path from the first area to the selective one of the target areas comprising selectively determining a first path from the first area to a first target area or a second path from the first area to a second target area, and
reversibly blocking the path for the consecutive livestock animal comprising blocking an entrance to the first area for a next livestock animal and/or blocking the first path and the second paths for the next livestock animal when the first livestock animal is in the first area and unblocking the path for the consecutive livestock animal or the first and second paths for the consecutive livestock animal when the first livestock animal is out of the first area.

3. The system according to claim 1, wherein for each lever gate, the one or more first gate leaves are movable from a first position for blocking at least part of the first and second paths to a second position for defining at least one of the first and second paths, and the one or more second gate leaves are configured to move with the first gate leaves from a third position of the one or more second gate leaves associated with the first position of the one or more first gate leaves to a fourth position of the one or more second gate leaves associated with the second position of the one or more first gate leaves.

4. The system according to claim 1, wherein at least one of the lever gates comprises a first gate leaf wherein when unlocked, one of the livestock animals can push the first gate leaf out of its way in order to move along the selected one of the first and second paths.

5. The system according to claim 1, wherein at least one of the lever gates is configured for being urged to a default configuration and/or position using gravity.

6. The system according to claim 1, wherein the one or more first gate leaves of the opposite gates and/or the one or more second gate leaves of the opposite gates are configured for at least in part at least one of crossing, overlapping, and interleaving each other for blocking a path for at least one of the livestock animals.

7. The system according to claim 1, comprising one or more controllable magnet locks for the selective locking of one or more of the lever gates.

8. The system according to claim 1, comprising an alley for restricting passage by the livestock animals to single file to the gate assembly.

9. The system according to claim 1, comprising an identification module for providing an identification signal associated with one or more of the livestock animals, and a controller for controlling locking of at least one of the lever gates based on the identification signal.

10. A method for controlling movement of livestock animals, from a first area to a selective ones of target areas, comprising
providing a plurality of the livestock animals and a system according to claim 1;
selecting the target area for a first livestock animal; and
controlling locking of the selectively lockable laterally opposite lever gates to determine a path from the first area to the selected target area for the first livestock animal by selectively allowing movement of the one or more first gate leaves of each lever gate.

11. The method according to claim 10, wherein determining the path from the first area to the selective one of the target areas comprises selectively determining a first path from the first area to a first target area or a second path from the first area to a second target area.

12. The method according to claim 10, comprising
reversibly blocking the path for a consecutive livestock animal, comprising:
blocking an entrance to the first area for a next livestock animal and/or;
blocking of the first and second paths for the next livestock animal when the first livestock animal is in the first area and unblocking the first and second paths when the first animal is out of the first area.

13. The method according to claim 10, comprising identifying the livestock animal and selectively locking and/or unlocking at least one gate leaf from the one or more first and second gate leaves for allowing the livestock animal to pass from the first area to the selected target area.

14. The method according to claim 10, comprising allowing and/or urging the livestock animal to push at least one gate leaf from the one or more first and second gate leaves of the system out of its way in order to move along the one of the selected first and second paths.

15. The system according to claim 1, wherein two opposite lever gates each comprise a first gate leaf, wherein when unlocked, the livestock animal can push the first gate leaf out of its way in order to move along the selected one of the first and second paths.

16. The system according to claim 1, wherein the livestock animal is a cow.

17. The system according to claim 1, wherein at least one of the lever gates is configured to be urged to a default configuration or position by a resilient portion and/or an actuator.

18. The system according to claim 1, comprising one or more controllable electromagnetic locks for the selective locking of one or more of the lever gates.

19. The system according to claim 1, wherein the separation gate assembly is configured to be operated by the first livestock animal for separating the first and consecutive animals.

20. The method according to claim 10, wherein the livestock animal is a cow.
